(19) United States
(12) Patent Application Publication
(10) Pub. No.: US 2011/0305605 A1
(43) Pub. Date: Dec. 15, 2011

(54) PROTECTIVE COATING FOR METALLIC SURFACES AND PRODUCTION THEREOF

(75) Inventors: Frank Kleine Jaeger, Bad Duerkheim (DE); Dirk Grossschmidt, Mannheim (DE); Juergen Korkhaus, Wachenheim (DE); Bernd Rumpf, Hockenheim (DE); Ralph Nonninger, Saarbruecken (DE); Olaf Binkle, Kirkel (DE); Frank Meyer, Saarbruecken (DE)

(73) Assignee: BASF SE, LUDWIGSHAFEN (DE)

(21) Appl. No.: 13/203,415

(22) PCT Filed: Feb. 11, 2010
(86) PCT No.: PCT/EP10/51741

§ 371 Date: Aug. 25, 2011

(30) Foreign Application Priority Data
Feb. 26, 2009 (DE) 102009012003.3

(51) Int. Cl. B01J 19/00; B05D 3/12; B32B 15/04; B05D 3/02

(52) U.S. Cl. 422/241; 427/372.2; 427/383.7; 427/240; 428/341

(57) ABSTRACT

This specification describes the use of a composition comprising a nanoscale powder, a porous ceramic powder and a solvent for protecting a metallic surface against chemical attacks at high temperatures, in particular in a reducing and/or carburizing atmosphere, and also a corresponding process. Furthermore, this specification describes a plant part having a metallic surface which, in the operating state, is exposed to a reducing and/or carburizing atmosphere, wherein the surface is coated with a porous protective coating having a specific surface area of at least 20 m²/g.

The present invention relates to a protective coating for metallic surfaces for protecting the latter against chemical attacks in the high-temperature range. This specification describes the production of such a coating, and also plant parts having such a coating.

High-temperature corrosion refers to a chemical process at high temperatures, during which reactions occur between a material and a surrounding medium (generally a hot gas) and lead to damage to the material. The damage is similar to that which arises in the case of wet corrosion, thus in principle all possible forms of corrosion such as uniform areal corrosion and pitting can occur.

Such damage is not always the result of scaling (oxidation by oxygen), however, but can frequently also be caused by the presence of carbon. If a metallic material comes into contact with a low-oxygen gas mixture containing carbon monoxide, methane or other carbon-containing constituents at high temperatures, so-called carburization of the material can occur, particularly in the case of low oxygen contents. Carburization is conventionally a process for treating steels which, on account of their low carbon content, cannot be hardened or can be hardened only poorly. In the process, the edge layer of the steels is enriched with carbon so that martensite can form there and a hard edge layer can arise. If the carbon content in the steel exceeds a certain limit, however, the steel becomes brittle. Metal carbides form, and these in turn are decomposed to form carbon and loose metal particles, in which case pitting can occur locally in particular. These effects brought about by carburization are referred to as “metal dusting”.

Carburizing, reducing conditions under which metal dusting effects occur very frequently are found, in particular, in coal gasification, in petrochemical processing, here in particular in cracking (steam cracker), in coal liquefaction and gasification, in synthesis gas reactors (steam reformer), in plants for processing synthesis gas, for example in methane production, and in the production of ammonia. Further industrial-scale plants in which metal dusting plays a role are, in particular, plants in which hydrogenation reactions and dehydrogenation reactions are carried out.

It is known that metal dusting effects can be prevented by the addition of precisely dosed quantities of sulfur. Elemental sulfur can be adsorbed on metal surfaces and then blocks the surface for the accumulation of carbon. However, the use of sulfur is not always possible for a variety of reasons. For example, sulfur is firstly known to be a strong catalyst poison, and secondly the use of sulfur can entail the formation of sulfuric acid, which for its part can lead to damage.

It is also known to protect against metal dusting by forming protective layers in a targeted manner on metallic surfaces. By way of example, US 2008/0020216 describes the formation of a metal layer (containing nickel and aluminum) on the surface of steels, on which metal layer an oxide layer preferably containing aluminum oxide, chromium oxide, silicon dioxide and/or mullite is formed in a second step.

EP 799639 discloses a metal surface which is protected against metal dusting and has an insulating layer consisting of gas-permeable, thermally insulating material. This insulating layer shields the metal surface from hot gases during operation. It preferably consists of porous insulating concrete, porous molded blocks or a layer of ceramic fibers.

EP 0724010 also has a similar disclosure. Said document describes a porous layer of a thermally insulating compound, with which a hot-gas line is protected against carbide formation. No information is provided in relation to the composition of the thermally insulating protective compound.

EP 1717330 describes a metal pipe intended, in particular, for use in a carbon-containing gas atmosphere. The surface of the metal pipe is enriched with copper, wherein the proportion of copper is at least 0.1 atomic percent.

US 2005/0170197 discloses a composition which is resistant to metal dusting. This is an alloy which can form a titanium carbide coating on its surface in carbon-containing atmospheres.

It is known from DE 10116762 to improve the corrosion resistance of metallic materials at high temperatures in reducing, sulfidizing and/or carburizing atmospheres by forming a metallic protective layer on the surface of the materials in a co-diffusion process. Said document proposes the use of the diffusion elements aluminum and titanium in the form of pure metal powders in a weight ratio of 1:0.1-5.

A further coating for protection against corrosion effects such as metal dusting is known from DE 10104169. This patent application describes that the hydrolysis and polycondensation of one or more silanes produces a layer-forming gel on the surface of the materials to be protected, which gel is then sintered to form a dense, inorganic protective layer by subsequent heat treatment.

Some of the procedures already known provide very effective protection against metal dusting, but are predominantly complex and expensive. There continues to be a need for further solutions for protecting materials and plant parts at risk of metal dusting. The present invention was based on the object of finding such a solution. The solution was to be as easy as possible to realize in technical terms and also cost-effective, and the resulting protection against metal dusting was to be at least as efficient as in the procedures known from the prior art.

The object is achieved by the use having the features of claim 1 and by the process having the features of claim 2. Preferred embodiments of the process according to the invention and of the use according to the invention can be found in dependent claims 3 to 18. Furthermore, the present invention also relates to the plant part as claimed in claim 19. Preferred embodiments of this plant part are given in claims 20 to 22. The wording of all the claims is hereby incorporated in this description by reference.

EP 1427870 discloses a self-cleaning ceramic layer for baking ovens and also a process for producing such a layer. In order to produce such a layer, a batch of at least one porous ceramic powder and also an inorganic binder system containing at least one nanoscale powder and a solvent is formed. This batch is then applied to metal sheets, which form the inner walls of a baking oven, and hardened. The resulting porous ceramic layers have a very high suction capacity. Organic impurities which arise can be transported into the interior of the layer, where they are distributed over a very large (inner) surface. As a result, the impurities can decompose even at temperatures from 250° C. without the need for a catalyst.

Surprisingly, it has now been found that such a layer is also outstandingly suitable for preventing damage to metallic surfaces as a result of metal dusting.

The present invention therefore relates in particular to the use of a composition comprising a nanoscale powder, at least one porous ceramic powder and a solvent for protecting a surface against chemical attacks at high temperatures. The present invention likewise relates to a process for protecting a metallic surface against chemical attacks at high temperatures using said composition.

As already mentioned in the introduction, damage arises as a result of metal dusting particularly in a reducing and/or carburizing atmosphere at high temperatures, as is present in particular in chemical and petrochemical plants. Within the context of the present application, “high temperatures” are to be understood to mean temperatures of between 400 and 900° C., particularly preferably between 500 and 800° C.

The term “carburization” has already been mentioned in the introduction. Within the context of the present application, this is to be understood to mean, in particular, the diffusion of elemental carbon into a metal surface. The metal dusting to be prevented is a consequence of this diffusion.

Within the context of the present application, “a reducing atmosphere” is to be understood to mean, in particular, a low-oxygen atmosphere which is preferably substantially free of molecular oxygen. Reducing atmospheres are preferably distinguished by high proportions of hydrogen and/or carbon monoxide. A typical example of an atmosphere with reducing and carburizing properties is synthesis gas, already mentioned in the introduction, which is known to consist essentially of hydrogen and carbon monoxide.

With the porous ceramic powder and the nanoscale powder, the composition used according to the invention always comprises at least two solid components. Here, the nanoscale powder primarily has the function of a binder for the porous ceramic powder. It is generally not porous itself.

In preferred embodiments, however, the composition also contains one or more further components.

As such a further component, the composition can comprise, in particular, at least one spinel compound. This is preferably present as a powder. It is known that spinels are chemical compounds of the general type AB₂X₄, where A is a divalent metal cation, B is a trivalent metal cation and X is predominantly an oxide or sulfide. In particular, spinel compounds are used in industry as color pigments. Examples of spinels which are preferred according to the invention can be found further below.

Furthermore, it can be preferable for the composition used according to the invention to comprise at least one catalytically active component as a further component in addition to or instead of the at least one spinel compound, in particular from the group consisting of transition metal oxides, rare earth oxides and/or precious metals. It has been found that the protective action of the layer to be produced can be improved even further by the addition of these components.

It is optionally possible for further ceramic powders, in particular a third ceramic powder, to also be admixed to the composition, preferably for the targeted setting of the porosity. The further ceramic powders do not have to be porous themselves.

Within the context of the present application, the term “nanoscale powder” is to be understood to mean, in particular, a powder which is composed of particles having a mean particle size of between 5 nm and 100 nm, in particular between 5 nm and 50 nm.

The nanoscale powder preferably consists essentially of particles having a particle, size of between 1 nm and 100 nm, preferably between 1 nm and 50 mm. Therefore, the nanoscale powder preferably does not contain any particles having particle sizes above said upper-limits.

The mean particle size of the porous ceramic powder is preferably considerably greater than the mean particle size of the nanoscale powder. It generally exceeds the mean particle size of the nanoscale powder at least by a factor of 2, preferably at least by a factor of 5, in particular at least by a factor of 10. With particular preference, it is between 1 μm and 200 μm, preferably between 1 μm and 100 μm.

The porous ceramic powder preferably consists essentially of particles having a particle size of between 500 nm and 200 μm, preferably between 500 nm and 100 μm.

Nanoparticles have an extraordinarily large specific surface area which is generally occupied by reactive groups, in particular by hydroxyl groups. The surface groups of the nanoparticles are able, even at room temperature, to crosslink with the surface groups of relatively coarse materials, e.g. in the present case the porous ceramic powder. On account of their high radii of curvature, nanoparticles also have extremely high surface energies. Even at relatively low temperatures, this high surface energy can lead to material transport (diffusion) of the nanoparticles toward the points of contact of relatively coarse particles. (of the porous ceramic powder) to be bound. The use of the nanoparticles in the composition used according to the invention therefore makes it possible for the composition to solidify even at relatively low temperatures.

Since coarser particles such as those of the porous ceramic powder have much lower surface energies than the nanoparticles, material transport of the coarser particles does not take place or scarcely takes place at these low temperatures. As a result, it is possible to obtain an open-pored structure (with pores connected to one another) having an extremely high specific surface area.

This pore structure with a high specific surface area is of major significance for the efficiency of the layer produced on the metal surface to be protected. All of the parameters which can influence the structure therefore play an important role. These also include, in particular, the particle size distributions of the powders used. The present information regarding the particle size distribution, in particular regarding the mean particle sizes, relates to values which have been obtained by means of light scattering experiments or from X-ray diffractometry.

Accordingly, there are also preferred mean particle sizes for the at least one spinel compound and also for the at least one catalytically active component possibly present, such as the aforementioned transition metal oxide and/or the rare earth oxides and/or the precious metals mentioned. With very particular preference, these are between 50 nm and 5 μm, in particular between 100 nm and 1000 nm.

The third ceramic powder, which is optionally present, preferably has particles having a mean particle size of between 10 nm and 1 μm, preferably between 150 nm and 800 nm.

A further important parameter with regard to the porosity of the layer to be formed is of course the surface area of the porous ceramic powder used. The latter preferably has a specific surface area of at least 50 m²/g, preferably >100 m²/g and particularly preferably >150 m²/g.

The inner surface of porous or granular solids comprises the totality of all surfaces present therein, i.e. also those which arise between the individual grains or through the pore edges. The actual measured variable for the inner surface is the aforementioned specific surface area. The specific surface area can be determined by means of various surface measurements. The present information regarding the specific surface area relates to values which have been obtained by means of a sorption process (in particular by means of a BET process).

The solvent used in a composition used according to the invention is preferably a polar solvent, very particularly preferably water. Alternatively, however, it is also possible to use alcohols, e.g. 2-butoxyethanol, ethanol, 1-propanol or 2-propanol, as a mixture or in combination with water.

Particles of aluminum oxide, AlO(OH), zirconium dioxide, titanium dioxide, silicon dioxide, Fe₃O₄, tin oxide or mixtures of these particles are preferably used as the nanoscale powder. With respect to the selection of suitable nanoparticles, reference is made to EP 1427870.

The porous ceramic powder used preferably consists of porous particles of an oxide, an oxide hydrate, a nitride or a carbide of the elements silicon, aluminum, boron, zinc, zirconium, cadmium, titanium or iron or of a mixture of these particles. Particular preference is given to oxidic powders, among these particularly aluminum oxide, boehmite, zirconium oxide, iron oxide, silicon dioxide and/or titanium dioxide. Silicates, rock flour, perlites or zeolites can also be used. Reference is also made to EP 142.7870 with respect to the selection of a suitable porous ceramic powder.

Returning to the spinel compounds already mentioned above: spinel compounds which contain iron, manganese, copper, cobalt, aluminum and/or chromium have proved to be particularly suitable. Within the context of the present invention, it is particularly preferable to use an iron-manganese-copper spinel.

Fundamentally, all known transition metal-based catalysts are suitable as the catalytically active component. It is particularly preferable to use silver, platinum, palladium and/or rhodium. Here, these can be used both in metallic form (e.g. as a sol) and in dissolved form (e.g. in the form of dissolved silver ions).

The third ceramic powder, which is optionally present, is in material terms preferably an oxide, an oxide hydrate, a chalcogenide, a nitride or a carbide of the elements Si, Al, B, Zn, Zr, Cd, Ti, Ce, Sn, In, La, Fe, Cu, Ta, Nb, V, No or W, preferably of Si, Zr, Al, Fe and/or Ti. It is particularly preferable to use oxides such as aluminum oxide. In addition, particles of boehmite, zirconium oxide, iron oxide, silicon dioxide, titanium dioxide, silicate and/or rock flour are also preferably used.

The content of porous ceramic powder in the composition is preferably between 20 and 90% by weight (based on the solids content of the composition). Within this range, further preference is given to values of between 50 and 80% by weight.

The content of nanoscale powder in the composition is, in particular, between 1 and 25% by weight; particularly preferably between 3 and 15% by weight. These values, too, relate in each case to the solids content of the composition.

The at least one spinel compound is usually present in the composition in a proportion of between 1 and 25% by weight. Proportions of between 3 and 15% by weight are particularly preferred (in each case based in turn on the solids content of the composition).

In addition to the components already mentioned, the composition used according to the invention can contain further components, including in particular fillers and additives. By way of example, the fillers can be ceramic fibers. Suitable additives are, in particular, dispersants, flow control agents and agents for setting the rheological properties of the composition used according to the invention. Suitable additives are known to a person skilled in the art and do not require a more detailed explanation.

If additives are added, they are done so in relatively small quantities, in particular in view of the aforementioned proportions of the components which are imperatively present. This applies equally to the at least one catalytically active component.

Fundamentally, the composition can be applied to the surface to be protected by any known application process. Particular preference is given to processes such as spin coating, dip coating, immersion, flooding and, in particular, spraying. In this respect, the optimum approach is governed by the consistency of the composition to be applied and the local conditions.

After the composition has been applied, it is as a rule left to dry. Solidification then takes place preferably at temperatures of at most 1200° C. Excessive temperatures are not favorable, since otherwise the layer can undergo dense sintering and the porosity is lost. Furthermore, the maximum possible sintering temperature is determined by the underlying metal substrate. Particular preference is given to a temperature range of between 200° C. and 1000° C.

As already mentioned, a protective layer according to the present invention serves, in particular, to protect against chemical attacks at high temperatures as occur in a reducing and/or carburizing atmosphere, which can be found in particular in the chemical and petrochemical plants mentioned in the introduction. Such a protective layer is effective if it has a high specific surface area.

Accordingly, the present invention relates to all plant parts having a metallic surface which, in the operating state, is exposed to a reducing and/or carburizing atmosphere, and which, on its surface, has a protective coating having a specific surface area of at least 20 m²/g.

The protective coating preferably has the above-mentioned open-pored structure and can be produced, in particular, from the above-described composition.

The porous protective coating particularly preferably has a specific surface area of at least 70 m²/g, particularly preferably more than 120 m²/g. A protective coating with such a porosity has an outstanding protective action against metal dusting.

The plant part according to the invention is particularly preferably part of a chemical or petrochemical plant, in particular a plant for coal gasification and/or for coal liquefaction for producing or processing synthesis gas, for producing ammonia, a hydrogenation or dehydrogenation plant or a steam cracker. In the simplest case, here, it can be a pipe, for example.

Further features of the invention will become apparent from the following description of preferred embodiments in conjunction with the figures and the dependent claims. In this respect, the individual features can respectively be realized by themselves or as a plurality in combination with one another in one embodiment of the invention. The preferred embodiments described serve merely for elucidation and for a better understanding of the invention and should in no way be understood to be restrictive.

### DESCRIPTION OF THE FIGURES

FIG. 1 shows an uncoated test sheet for carrying out metal dusting tests.

FIG. 2 shows the state of blank tests after exposure.

FIG. 3 shows the state a coated sample after exposure.

FIG. 4 shows the state of a further coated sample after exposure.

### EXAMPLES

### Example 1

### Production of the Coating Slurry 004Z_{T}

100 g of 2.5% strength HNO₃ are introduced as an initial charge. 1.7 g of trioxadecanoic acid, 4.8 g of a 3% strength solution of polyvinylpyrrolidone and also 1 g of a 20% strength solution of BYK 380N are added thereto in succession with stirring.

A mixture containing all the solid constituents of the slurry is produced in a powder mixer at the same time. To this end, 147.4 g of Al₂O₃ (mean particle size 80 μm), 31.72 g of Al₂O₃ (mean particle size 0.7 μm) and also 21 g of an iron-manganese-copper spinel pigment are introduced into the powder mixer in succession and intimately mixed for one hour. This powder mixture is added to the already premixed aqueous components, and mixing is carried out for a further 30 minutes by means of a dissolver. 28.4 g of an aqueous nanoscale ZrO₂ suspension (40% by weight solid material) and also a further 6.9 g of water as liquefier are finally added to said mixture. This mixture is stirred for a further 30 minutes. Alternatively, the entire mixture or parts thereof can be homogenized by a pass in a stirred ball mill (Drais mill or attritor). The finished coating slurry is called 004Z_{T}.

### Example 2

### Production of the Coating Slurry 004T2T

103 g of 2.5% strength HNO₃ are introduced as an initial charge. 1.7 g of trioxadecanoic acid, 4.8 g of a 3% strength solution of polyvinylpyrrolidone and also 1 g of a 20% strength solution of BYK 380N are added thereto in succession with stirring.

A mixture containing all the solid constituents of the slurry is produced in a powder mixer at the same time. To this end, 151.9 g of Al₂O₃ (mean particle size 80 μm), 32.6 g of Al₂O₃ (mean particle size 0.7 μm) and also 21.7 g of an iron-manganese-copper spinel pigment are introduced into the powder mixer in succession and intimately mixed for one hour. This powder mixture is added to the already premixed aqueous components, and mixing is carried out for a further 30 minutes by means of a dissolver. 28.4 g of an aqueous nanoscale TiO₂ suspension (41% by weight solid material) are finally added to said mixture. This mixture is stirred for a further 30 minutes. Alternatively, the entire mixture or parts thereof can be homogenized by a pass in a stirred ball mill (Drais mill or attritor). The finished coating slurry is called 004T2T.

### Example 3

### Production of the Coating Slurry 002C4

43.8 g of 2.5% strength HNO₃ are introduced as an initial charge. 1.1 g of trioxadecanoic acid, 2.9 g of a 3% strength solution of polyvinylpyrrolidone and also 0.6 g of a 20% strength solution of BYK 380N are added thereto in succession with stirring.

A mixture containing all the solid constituents of the slurry is produced in a powder mixer at the same time. To this end, 98.3 g of Al₂O₃ (mean particle size 80 μm), 14.9 g of Al₂O₃ (mean particle size 0.7 μm) and also 11.9 g of an iron-manganese-copper spinel pigment are introduced into the powder mixer in succession and intimately mixed for one hour. This powder mixture is added to the already premixed aqueous components, and mixing is carried out for a further 30 minutes by means of a dissolver. 36.4 g of an aqueous nanoscale CeO₂ suspension (20% by weight solid material) are finally added to said mixture. This mixture is stirred for a further 30 minutes. Alternatively, the entire mixture or parts thereof can be homogenized by a pass in a stirred ball mill (Drais mill or attritor). The finished coating slurry is called 002C4.

### Example 4

### Production of the Slurry T2T(80%)C5D(20%)

65 g of 2.5% strength HNO₃ are introduced as an initial charge. 1.2 g of trioxadecanoic acid, 3.1 g of a 3% strength.solution of polyvinylpyrrolidone and also 0.7 g of a 20% strength solution of BYK 380N are added thereto in succession with stirring.

A mixture containing all the solid constituents of the slurry is produced in a powder mixer at the same time. To this end, 103.3 g of Al₂O₃ (mean particle size 80 μm), 15.6 g of Al₂O₃ (mean particle size 0.7 μm) and also 12.5 g of an iron-manganese-copper spinel pigment are introduced into the powder mixer in succession and intimately mixed for one hour. This powder mixture is added to the already premixed aqueous components, and mixing is carried out for a further 30 minutes by means of a dissolver. 14.9 g of an aqueous nanoscale TiO₂ suspension (41% by weight solid material) and also 4.3g of an aqueous nanoscale CeO₂ suspension (36% by weight solid material) are finally added to said mixture. This mixture is stirred for a further 30 minutes. Alternatively, the entire mixture or parts thereof can be homogenized by a pass in a stirred ball mill (Drais mill or attritor). The finished coating slurry is called T2T(80)C5D(20).

### Example 5

### Synthesis of a Platinum Sol

The synthesis of a platinum sol which is stabilized with PVP (polyvinylpyrrolidone) and has longterm stability was carried out by means of reduction with methanol using hexachloroplatinic(IV) acid as the precursor. To this end, PVP and hexachloroplatinic(IV) acid are dissolved in a water/methanol mixture. A 0.1 N solution of NaOH in methanol is added dropwise with stirring. The reaction mixture is back-flushed until a homogeneous, dark colloidal platinum solution is formed. The colloid is stable and transparent over months. Characterization by means of TEM showed that very homogeneous platinum particles which are deagglomerated to the greatest possible extent and have a diameter of about 5 nm are present.

(Citation: Journal of Colloid and Surface Science 210, 218-221 (1999): Preparation of Polymer-Stabilized Noble Metal Colloids)

### Example 6

### Synthesis of Nanoscale CeO₂

Basic precipitation with subsequent hydrothermal treatment was selected for the production of cerium dioxide nanoparticles. Proceeding from cerium(III) nitrate hexahydrate, pulverulent, cubic CeO₂ having crystallite sizes of 10 nm (according to Scherrer) is obtained via precipitation with aqueous ammonia, subsequent hydrothermal treatment at 250° C. in a pressure digestion vessel and after removal by centrifuging and calcination.

### Example 7

### Metal Dusting Tests—Coating of Test Laminae

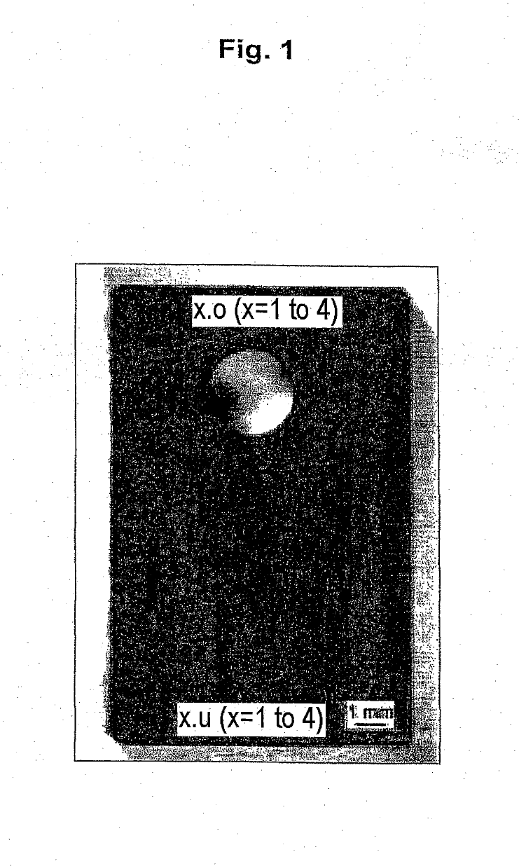

A Dremel was used to make marks on the shorter side of the lamina to be coated (size: 20×15 mm) for later identification of the samples. The sample designation results from the different number of scratches which were milled into the edge face. The sample designation x.o (where x=1 to 4) means that the marks were milled in on the side of the hole, whereas the samples having the designation x:u (where=1 to 4) have the marks on the side opposite from the hole (see FIG. 1).

Coating

All substrates were sand-blasted and degreased with isopropanol before coating.

| Sample designation | Coating |
|---|---|
| 0 (=no indentation) | Coating 004T2_{T} + impregnated |
| | with Ag solution (0.8%) |
| 1.u (=1 indentation on the | Coating 004T2_{T} + impregnated |
| side opposite from the hole) | with Pt colloid |
| 2.u. (=2 indentations on the | Coating 004T2_{T} + impregnated |
| side opposite from the hole) | (green) with CeO₂ (0.5% in |
| | distilled H₂O) + sintered |
| 3.u (=3 indentations on the | Coating 004T2_{T} + impregnated |
| side opposite from the hole) | with CeO₂ (0.5% in distilled |
| | H₂O) |
| 4.u (=4 indentations on the | Coating 002 C4 (with CeO₂ sol |
| side opposite from the hole) | from Nyacol as nano binder) |
| 1.o (=1 indentation on the | Coating 004T2_{T} + Pt |
| side of the hole) | (proceeding from H₂Cl₆Pt * |
| | 6H₂O and reduced with forming |
| | gas) |
| 2.o (=2 indentations on the | Coating 004T2_{T} + Pd |
| side of the hole) | (proceeding from PdCl₂ and |
| | reduced with forming gas) |
| 3.o (=3 indentations on the | Coating 004T2_{T} + Rh |
| side of the hole) | (proceeding from RhCl₃ * 3H₂O |
| | and reduced with forming gas) |
| 4.o (=4 indentations on the | Coating 002 T2_{T}(80)/C5_{D}(20) |
| side of the hole) | (i.e. with CeO₂ and TiO₂ mixed |
| | nano binder) |

In each case two laminae were coated with the same coating material. With the exception of samples 4.u and 4.o, the starting material for all samples was the coating 004T2_{T}, which contains TiO₂ nano binder.

The coatings were subsequently impregnated with precious metals or CeO₂. The layers of the two samples 4.u and 4.o were produced using a CeO₂ nano binder and a TiO₂/CeO₂ mixed nano binder, respectively.

The laminae were all coated by spraying using a Mini Sata Jet spray gun having a 1.0 mm nozzle at a pressure of 1.5 bar.

Overview of the Samples
a) Sample 0 (no indentations): Coating 004T2_{T}30 impregnated with Ag solution (0.8%)

After drying (85° C./1 h) and firing (830° C./5 min) of the layer, a 0.8% strength silver solution was applied dropwise using a pipette, such that the coating was completely impregnated. The exact amount which was applied dropwise was not determined. The silver solution was made using a water-dispersible, colloidal Silver powder. The samples were then dried at 85° C./1 h and then at 300° C./2 d.
b) Sample 1.0 (1 indentation on the side opposite from the hole): Coating 004T2_{T}+impregnated with Pt colloid

After drying (85° C./1 h) and firing (830° C./5 min) of the layer, a colloidal platinum solution (180 ppm Pt concentration) was applied dropwise using a pipette, such that the coating was completely impregnated. The exact amount which was applied dropwise was not determined. The synthesis of the platinum sol which was stabilized with PVP (polyvinylpyrrolidone) and had long-term stability was carried out by means of reduction with methanol using hexachloroplatinic(IV) acid as the precursor The samples were then dried at 85° C./1 h and then at 300° C./2 d.
c) Sample 2.u (2 indentations on the side opposite from the hole): Coating 004T2_{T}+impregnated (on green ceramic) with CeO₂ solution (0.5.% in distilled H₂O)

After drying of the layer at room temperature; a 0.5% strength n-CeO₂ solution was applied dropwise to the green ceramic layer using a pipette, such that the coating was completely impregnated but the green ceramic layer was not detached. The exact amount which was applied dropwise was not determined. The samples were then dried at 85° C./1 h and then fired at 830° C./5 min. The nanoscale CeO₂ powder was produced, proceeding from cerium(III) nitrate hexahydrate, via precipitation with aqueous ammonia and subsequent hydrothermal treatment at 250° C. in a pressure digestion vessel.

d) Sample 3.u (3 indentations on the side opposite from the hole): Coating 004T2_{T}+impregnated (on sintered ceramic) with CeO₂ solution (0.5% in distilled H₂O)

After drying (85° C./1 h) and firing (830° C./5 min) of the layer, a 0.5% strength n-CeO₂ solution was applied dropwise using a pipette, such that the coating was completely impregnated. The exact amount which was applied dropwise was not determined. The samples were then dried at 85° C./1 h and then at 300° C./2 d.
d) Sample 4.u (4 indentations on the side opposite from the hole): Coating 002 C4 with CeO₂ sol in the slurry

These samples differ from the other samples in that the slurry contains a commercially available CeO₂ sol (solid material: 20%) instead of the TiO₂ nano binder. The slurry was not subsequently impregnated with the CeO₂ sol, but instead the sol was added to the slurry. The coating was dried at 85° C./1 h and then fired at 830° C./5 min.

e) Sample 1.o (1 indentation on the side of the hole): Coating 004T2_{T}+Pt (reductive)

After drying (85° C./1 h) and firing (830° C./5 min) of the layer, a solution of hexachloroplatinic(IV) acid hexahydrate in water (3000 ppm) was applied dropwise using a pipette, such that the coating was completely impregnated. The impregnated samples were treated with forming gas (10% by volume H₂ in N₂) at temperatures of 500° C. for two hours in order to achieve reduction of the platinum.

f) Sample 2.o (2 indentations on the side of the hole): Coating 004T2_{T}+Pd (reductive)

After drying (85° C./1 h) and firing (830° C./5 min) of the layer, a solution of palladium(II) chloride in water (3000 ppm) was applied dropwise using a pipette, such that the coating was completely impregnated. The impregnated samples were treated with forming gas (10% by volume H₂ in N₂) at temperatures of 500° C. for two hours in order to achieve reduction of the palladium.

g) Sample 3.o (3 indentations on the side of the hole): Coating 004T2_{T}+Rh (reductive)

After drying (85° C./1 h) and firing (830° C./5 min) of the layer, a solution of rhodium(III) chloride trihydrate in water (3000 ppm) was applied dropwise using a pipette, such that the coating was completely, impregnated. The impregnated samples were treated with forming gas (10% by volume H₂ in N₂) at temperatures of 500° C. for two hours in order to achieve reduction of the rhodium.

h) Sample 4.o (4 indentations on the side of the hole): Coating 004T2_{T}/C5_{D}

These samples differ from the other samples in that the slurry contains both TiO₂ nano binder and CeO₂ nano binder (n-CeO₂ from the CeO₂ synthesis described milled with a polyacrylate as surface dispersant) in the ratio 80:20 (formulation 004T2_{T}(80)/C5D(20)). The samples were dried at 85° C./1 h and then fired at 675° C./1 h.

Description of the Tests and Results

The samples described above were hung in a rack made of quartz and the sample rack was mounted in the quartz tube of a vertical tube furnace. The furnace was heated up as the quartz tube was being flushed with nitrogen. When the holding temperature of 650° C. was reached, a change was made to a gas mixture of 74% by volume H₂, 24% by volume CO and 2% by volume H₂O. The volumetric flow rate of the gas was 20 l/h at room temperature. A pressure of 1.5 bar was set. The total exposure time of the samples under these conditions was 3 weeks (504 h). After the furnace was switched off, the samples cooled down in the furnace on flushing with nitrogen, and the state of the samples was documented.

The results can be discussed on the basis of visual assessment.

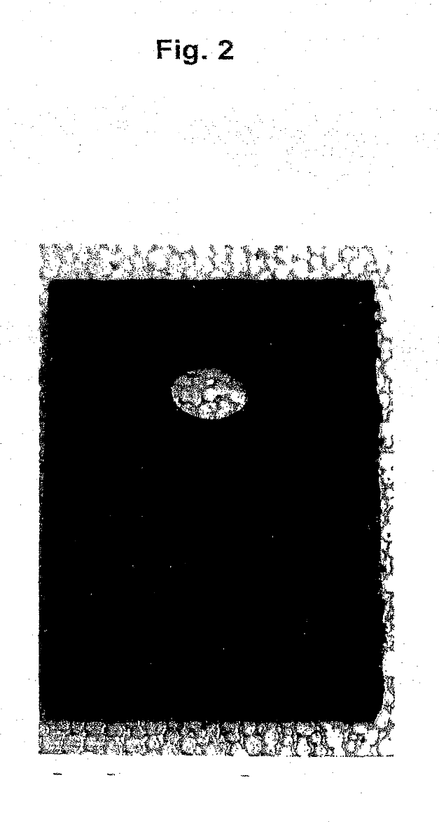

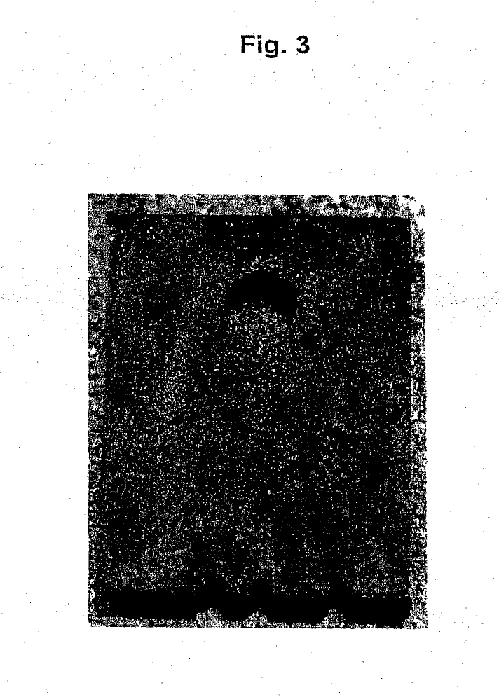

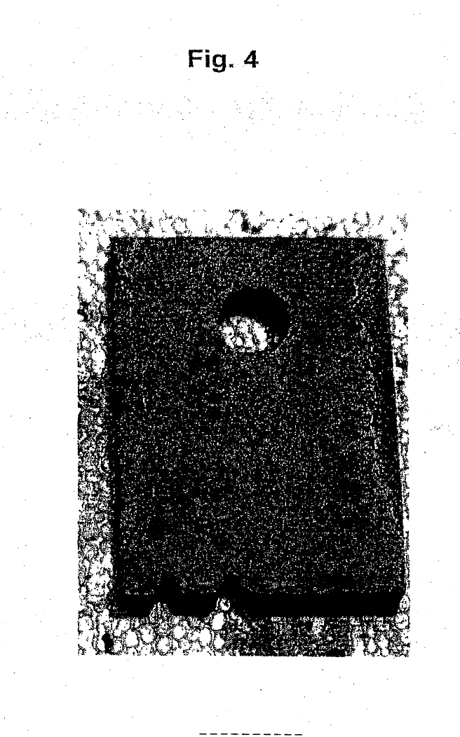

FIG. 2 shows the state of a blank test after exposure. Severe precipitation of carbon can clearly be seen. By contrast, no or minor precipitation of carbon occurs after exposure for the coated samples, as FIGS. 3 and 4 show, for example, on samples 3.u and 2.u. It is clear that here an attack on the substrate was able to be successfully prevented by the coating. The other examples mentioned in the table above gave similar results.

1.-22. (canceled)

23. A process for protecting a metallic surface against chemical attacks at high temperatures, in particular in a reducing and/or carburizing atmosphere, wherein a layer-forming composition comprising a nanoscale powder, a porous ceramic powder and a solvent is applied to the metal surface to be protected and is solidified.

24. The process of claim 1, further comprising at least one spinel compound.

25. The process of claim 1, further comprising at least one catalytically active component selected from the group consisting of: transition metal oxides, rare earth oxides and/or precious metals.

26. The process of claim 1, wherein a mean particle size of the nanoscale powder is between 5 nm and 100 nm, preferably between 5 nm and 50 nm.

27. The process of claim 1, wherein a mean particle size of the porous ceramic powder is between 1 μm and 200 μm, preferably between 1 μm and 100 μm.

28. The process of claim 2, wherein the at least one spinel compound is used as a powder having a mean particle size of between 50 nm and 5 μm.

29. The process of claim 1, characterized in that the porous ceramic powder has a specific surface area of at least 50 m²/g, preferably >100 m²/g and particularly preferably >150 m²/g.

30. The process of claim 1, characterized in that the solvent is a polar solvent, in particular water.

31. The process of claim 1, characterized in that particles of Al₂O₃, AlO(OH), ZrO₂, TiO₂, SiO₂, Fe₃O₄, SnO₂ or mixtures of these particles are used as the nanoscale powder.

32. The process of claim 1, characterized in that porous particles of an oxide, an oxide hydrate, a nitride and a carbide of the elements Si, Al, B, Zn, Zr, Cd, Fe or Ti or mixtures of these particles are used as the porous ceramic powder.

33. The process of claim 2, characterized in that an iron-manganese-copper spinel is used as the spinel compound.

34. The process of claim 3, characterized in that silver, platinum, palladium and/or rhodium is used as the catalytically active component.

35. The process of claim 1, characterized in that the content of porous ceramic powder in the composition is between 20 and 90% by weight, preferably between 50 and 80% by weight (in each case based on the solids content of the composition).

36. The process of claim 1, characterized in that the content of nanoscale powder in the composition is between 1 and 25% by weight, preferably between 3 and 15% by weight (in each case based on the solids content of the composition).

37. The process of claim 2, characterized in that the at least one spinel compound is present in the composition in a proportion of between 1 and 25% by weight, preferably between 3 and 15% by weight (in each case based on the solids content of the composition).

38. The process as claimed in claim 1, characterized in that the composition is applied to the metallic surface to be protected by processes such as spin coating, dip coating, immersion, flooding and preferably spraying.

39. The process as claimed in claim 1, characterized in that the composition is dried and is solidified at temperatures of up to 1200° C., preferably between 200° C. and 1000° C.

40. A plant part, characterized in that it has a metallic surface which, in the operating state, is exposed to a reducing and/or carburizing atmosphere, characterized in that the surface is coated with a porous protective coating, the latter having a specific surface area of at least 20 m²/g, preferably more than 70 m²/g, particularly preferably more than 120 m²/g.

41. The plant part as claimed in claim 40, characterized in that the protective coating is produced by a process for protecting a metallic surface against chemical attacks at high temperatures, in particular in a reducing and/or carburizing atmosphere, wherein a layer-forming composition comprising a nanoscale powder, a porous ceramic powder and a solvent is applied to the metal surface to be protected and is solidified.

42. The plant part as claimed in claim 40, characterized in that it is part of a chemical or petrochemical plant, in particular a plant for coal gasification or for coal liquefaction, for producing or processing synthesis gas, for producing ammonia, a hydrogenation or dehydrogenation plant or a steam cracker.

43. The plant part as claimed in claim 40, characterized in that the protective coating has an open-pored structure.
